(19) United States
(12) Patent Application Publication
(10) Pub. No.: US 2005/0150468 A1
(43) Pub. Date: Jul. 14, 2005

(54) Cat toy

(76) Inventor: Theresa R. Fleischhacker, Danville, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/055,853

(22) Filed: Mar. 26, 2002

(51) Int. Cl. A01K 29/00

(52) U.S. Cl. 119/708

(57) ABSTRACT

Cat Toy with a fishing reel and rod type assembly including a reel a rod and a handle, a hollow mouse shaped housing, a tether that connects the mouse housing with the real, the handle being hollow and containing a battery power source and a gear reduced electric motor who's output shaft is connected to the real so that when a person presses a switch on top of the handle, the tether is wound onto the reel, the hollow mouse body containing an electric motor having an off set weight attached to its shaft, an audio circuit and speaker and a motion switch so that when a cat moves said mouse, said mouse vibrates and makes a noise, and said hollow mouse body containing a recessed portion and closure for said recessed portion that allows the user to insert cat nip or the like. A preferred embodiment includes wherein the final gear of gear reduction assembly said is slidably engaged with said reel shaft so that a person can push on said reel shaft to slip it away from said gear reduction assembly thereby allowing the user to freely cast out said tether and attached mouse.

### BACKGROUND OF THE INVENTION

This invention relates generally to the field of pet accessories, and more particularly to a cat Toy.

Owners of domestic cats often derive pleasure and enjoyment by playing with their cats.

To this end, a variety of cat toys have been designed and sold to cat owners. Some cat toys are independent items such as hollow balls fifth a movable bell element inside.

Other toys are tied to a tether that is in turn attached to a rod. Still other toys have cat nip embedded inside.

Although current cat toys provide enjoyment and exercise benefits to both the cat and its owner, current cat toys are limited in that the tether is restricted in length or, the from the following descriptions, taken in connection with the accompanying drawings, wherein, by way of illustration and example, an embodiment of the present invention is disclosed.

Cat Toy comprising: a fishing reel and rod type assembly including a reel a rod and a handle, a hollow mouse shaped housing, a tether that connects said mouse housing with said reel, said handle being hollow and containing a battery power source and a gear reduced electric motor who's output shaft is connected to said real so that when a person presses a switch on top of said handle, said tether is wound onto said reel, said hollow mouse body containing an electric motor having an off set weight attached to its shaft, an audio circuit and speaker and a motion switch so that when a cat moves said mouse, said mouse vibrates and makes a noise, and said hollow mouse body containing a recessed portion and closure for said recessed portion that allows the user to insert cat nip or the like.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a side view of the cat toy of the present invention

FIG. 2 is a side view of the present invention showing the drive gear disengaged

FIG. 3 is a side section view of the present invention

### DETAILED DESCRIPTION OF THE PREFERRED EMBODIMENTS

Detailed descriptions of the preferred embodiment are provided herein, It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

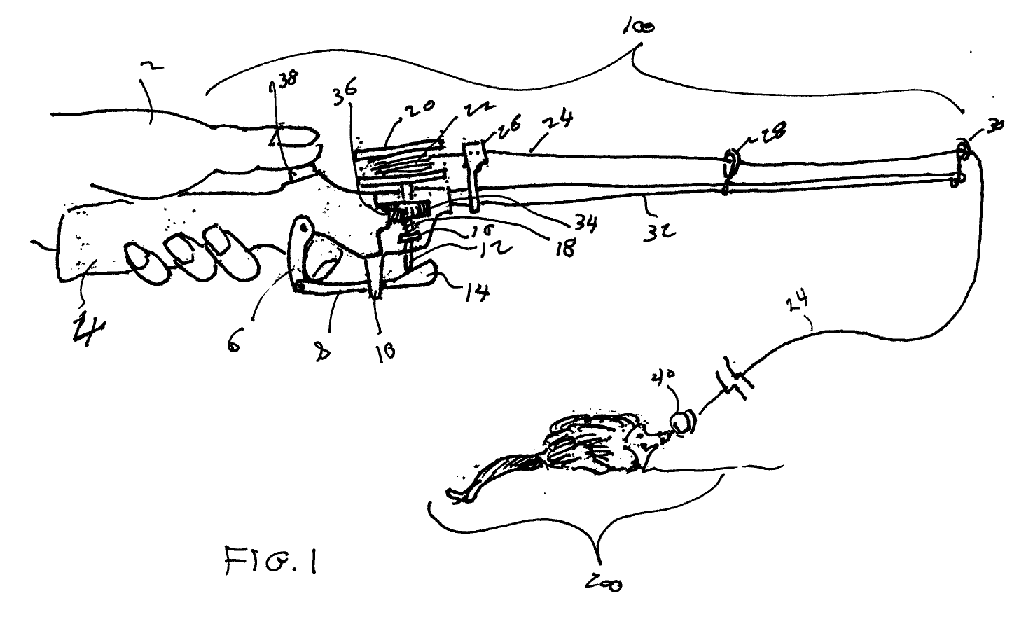

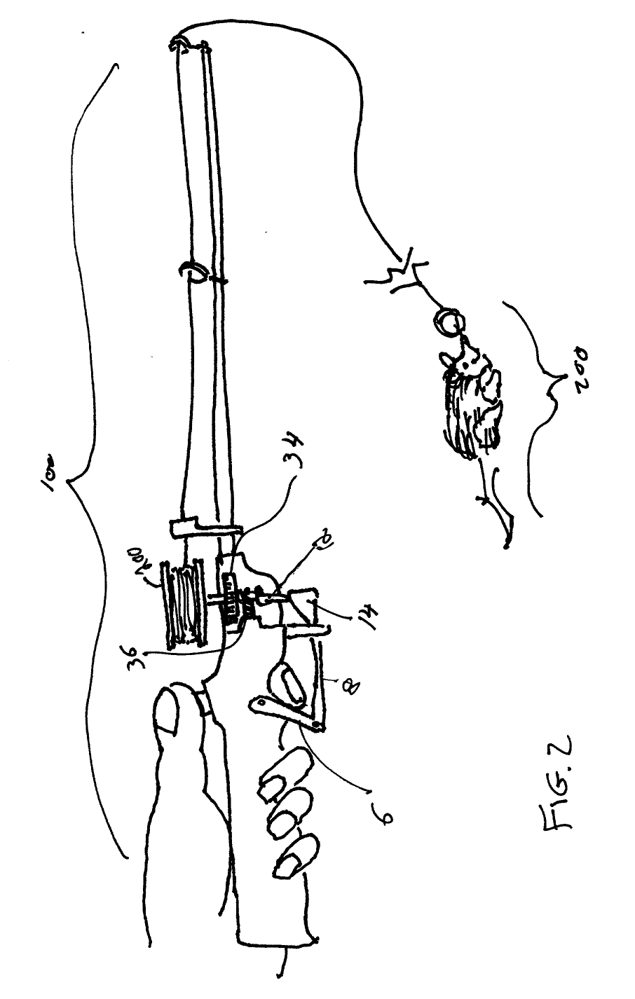

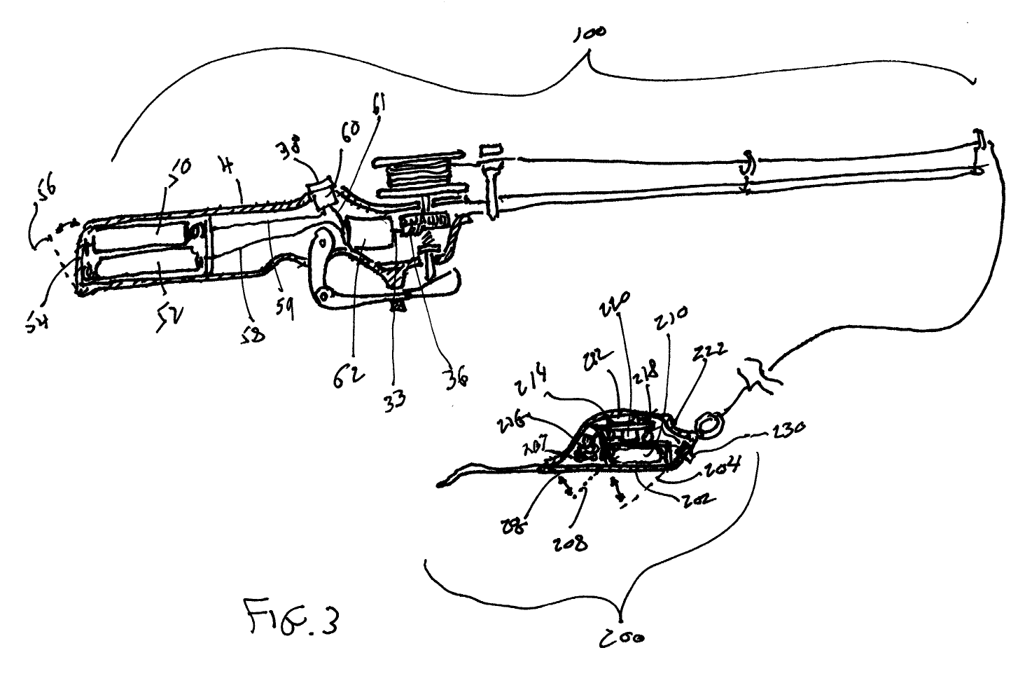

Referring now to FIG. 1 we see a side view of the cat toy of the present invention 100 and 200. The present invention is comprised of a rod and reel assembly 100 and a mouse toy assembly 200. The rod and reel assembly 100 is comprised of a handle 4 a reel assembly 20, a rod 32 and a tether 24 that is connected to mouse toy assembly 200. The reel 20 includes a central shaft 12 that is held in a spring biased fashion by spring 18 and retaining flange 10. The bottom tip of shaft 12 slidably interfaces with link 8 that is He shaped 14 at its forward end link 8 is slidably retained by link guide 10. Trigger 6 can be pulled back by the users finger 6 which is attached to the users hand 2. Worm gear 36 protrudes from handle housing 4 and engages drive gear 34 that is fixidly attached to reel shaft 12. When the user presses switch button 3B, a motor shown in FIG. 3, is activated and causes worm gear 36 to spin thereby causing drive gear 34 to revolve thereby causing reel 20 to revolve causing tether 24 to be drawn in to reel 20. Tether 24 is wound onto reel 20 and extends out through tether guide 26, 28 and 30 that are spaced along rod 32. The tether 24 terminates at its far end in mouse toy assembly 200. FIG. 2 shows the user pulling back on trigger 6 thereby causing linkage member 8 to draw back causing wedge shaped tip 14 to force shaft 12 up thereby disengaging drive gear 34 from worm gear 36. In this way, a person can cast the tether 24 and attached mouse toy assembly 200 out to a desired distance because the reel 20 is relatively friction free. FIG. 3 is a side section view of the present invention 100, 200. In this view we can clearly see that handle portion 4 is hollow and contains batteries 50 52 that can be accessed by battery door 54 as shown by dotted line 56. Momentary switch 60 can be seen that is activated by push button 38. Motor 62 can be clearly seen with motor shaft 33 fixedly attached to worm gear 36. Electrical wires 58, 59, 61 connect batteries 50, 52 with switch 60 and motor 62. Mouse toy assembly 200 is comprised of hollow mouse shaped housing 222 which encloses battery 210 and audio circuit 218 and speaker 212. Also contained in hollow mouse 222 is cat nip cavity 207 that can entrap cat nip 216 and can be accessed by cat nip door 206 as shown opened by dotted line 208. Battery 210 can be accessed by battery door 202 which can be seen in its open position by dotted line 204. Motor 220 and off set weight 214 causes a vibrating action when electrical power is provided. Motion sensing switch 218 causes intermittent power to be given to vibrator motor 220 and audio circuit 218 so that as a cat moves the mouse 200, it's intermittent action makes the mouse 200 appear to move and sound like it is alive. On off switch 230 turns power off to mouse electronics to conserve energy when not in use,

In the above described and illustrated way a person can use the present cat toy invention to entertain cats by casting out a mouse toy that appears to be alive because of its motion and sound qualities. The motorized reel assembly lets the user easily and quickly draw in the tether to prepare for the next cast out.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. Cat Toy comprising:
a fishing reel and rod type assembly including a reel a rod and a handle;
a hollow mouse shaped housing;
a tether that connects said mouse housing with said reel;
said handle being hollow and containing a battery power source and a gear reduced electric motor who's output shaft is connected to said real so that when a person presses a switch on top of said handle, said tether is wound onto said reel;
said hollow mouse body containing an electric motor having an off set weight attached to its shaft, an audio circuit and speaker and a motion switch so that when a cat moves said mouse, said mouse vibrates and makes a noise; and
said hollow mouse body containing a recessed portion and closure for said recessed portion that allows the user to insert cat nip or the like.

2. Cat Toy as claimed in claim 1 wherein the final gear of gear reduction assembly said is slidably engaged with said reel shaft so that a person can push on said reel shaft to slip it away from said gear reduction assembly thereby allowing the user to freely cast out said tether and attached mouse.
